(19) United States
(12) Patent Application Publication
(10) Pub. No.: US 2019/0261578 A1
(43) Pub. Date: Aug. 29, 2019

(54) Polyethylene spunbond nonwoven date-bunch covers

(71) Applicant: Stephen Paul Denis, Indio, CA (US)

(72) Inventor: Stephen Paul Denis, Indio, CA (US)

(21) Appl. No.: 15/932,457

(22) Filed: Feb. 27, 2018

(51) Int. Cl. A01G 13/02; B29C 65/00; B29C 65/02; B29C 65/48; B29C 65/62; A01G 13/10

(52) U.S. Cl. CPC A01G 13/0237; B29C 66/02241; B29C 66/7294; B29C 65/02; B29C 65/48; B29L 2031/7004; B29C 66/432; B29C 66/5324; B29C 66/71; A01G 13/105; B29K 2623/06; B29C 65/62

(57) ABSTRACT

Polyethylene spunbond nonwoven date-bunch covers are an urgently needed, price-competitive alternative to mesh covers made of synthetic monofilament yarn. They are the first improvement to the ideal date-bunch cover that USDA researchers theorized seventy years ago, by adding dust and mold spore exclusion, yet providing sufficient shade and vapor transmission for proper ripening. Black mold is insignificant even under close tree spacing and “wet summer” conditions. The lowered temperature and increased humidity inside the cover promotes pliable, smooth skin instead of dry and brittle as commonly occurs with covers made of monofilament mesh fabric. Covers made of polyethylene spunbond nonwoven fabric are lighter, less abrasive, compress easier, and thus are far more user-friendly. Ripe dates can be held on-tree longer than was ever possible before without accumulating dust or losing quality, which renders unnecessary the labor-intensive practice of multiple pickings, and saves cold storage costs.

### BACKGROUND OF THE INVENTION

### Field of the Invention

The present invention pertains generally to date-bunch covers, and particularly to a cover that encapsulates the bunch, protects the dates from rain, excludes insects and birds, allows aeration of the fruit cluster, and provides partial shade.

### Description of Related Prior Art

Banana growers worldwide use a protective cover made of light-weight polyethylene spunbond nonwoven fabric to exclude dust and insects, and to shade the banana bunch, while providing sufficient vapor permeability for offgassing of the fruit. (U.S. Pat. Appl. No. 20040062892) The cover accelerates ripening, increases bunch weight, and improves fruit quality by lowering the temperature and increasing humidity inside the cover. (National Research Centre for Banana, Tamil Nadu, India, 2013)

The North American monsoon has severely impacted the date crop four out of five seasons since 2013 in the United States and Mexico. Heavy rain and high humidity cause tearing of the date skin and make the flesh susceptible to disease, especially black mold. (Haas and Bliss, Hilgardia, 1935). Therefore, date growers have resorted to using date-bunch covers that combine wet-strength kraft paper, or plastic film, on top for rain protection, with porous, insect-proof, mesh fabric below to encapsulate the bunch. U.S. Pat. Appl. No. 20010051240 teaches a novel way of layering polyester mesh at the top of the cover to exclude rain. The mesh fabric comprising the lower portion of all these covers, although tight enough to exclude insects, allows windborne dust and mold spores to penetrate the cover and accumulate on the dates.

Compounding this problem is the trend to use mesh fabrics made of monofilament yarn, many of which have holes as large as possible that still keep out insects. Unfortunately, the larger the holes, the more exposed the dates are to dust, mold spores, desiccating winds, and sunburning, and the more likely the occurrence of skin separating from the flesh, a defect known as “puffy skin”.

In the early 1990s, a grant from the Organic Farming Research Foundation funded research by Ecosphere R&D in the Coachella Valley, Calif., which culminated with the invention of the combination kraft paper rain hood and polyester multifilament woven mesh cover that USDA researchers theorized as the ideal date-bunch cover seventy years ago, but the required fabric was lacking until the mid-1980s. (Date Growers' Inst. Rep. 26: 7-15, 1949, and Rep. 27: 7-12, 1950) However, due to its relatively high cost compared with various mesh fabrics now, especially those being imported, date growers are reluctant to invest in polyester multifilament woven mesh, despite its unsurpassed effectiveness, durability, and easy handling. They urgently need a price-competitive fabric for protecting the bunches without sacrificing fruit quality.

### BRIEF SUMMARY OF THE INVENTION

The preferred embodiment of the present invention comprises two panels of polyethylene spunbond nonwoven fabric which are joined horizontally in a tubular configuration sized to encapsulate a date bunch, the upper panel is rainproof and the lower panel is porous. The object is to protect the dates from rain, exclude insects, birds, dust and mold spores, partially shade the bunch, and enhance the microclimate about the dates.

An alternate embodiment comprises a tubular configuration sized to encapsulate a date bunch, which is made of porous polyethylene spunbond nonwoven fabric, in combination with a sheet of rainproof material that is wrapped around the upper portion of the bunch, either on the inside or outside of the tube-shaped cover, to form a rain hood. The object of the alternate embodiment is the same as that of the preferred embodiment.

The present invention offers four major advantages over the prior art:

(a) Polyethylene spunbond nonwoven fabric is lighter, less abrasive, and compresses more easily;
(b) The temperature inside the cover is lower and humidity higher, which improves fruit quality and promotes pliable, smooth, skin instead of dry and brittle as commonly occurs with mesh fabrics made of monofilament yam;
(c) Black mold is insignificant under close tree spacing and “wet summer” conditions despite increased humidity inside the cover (See: TABLES 1 and 2 below); and,
(d) Ripe dates can be held on-tree longer than was ever possible before without accumulating dust or losing quality, which obviates the labor-intensive practice of multiple pickings.

TABLE 1
2015 Field Trial Results
Date variety: Medjool
30 gsm (.9 oz) polyethylene spunbond nonwoven fabric
w/kraft paper hood inside
9 AUG 2015-14 NOV 2015
Location: Farnot Ranch, Thermal, California
No. of pickings: 1 Tree age: 8 yrs Spacing: 15′ × 16.6′ diamond
Rainfall: 1.3 mm (.05 in), 15 SEP 2015 and 11 mm (.42 in),
15 OCT-16 OCT 2015

| | Net | Black Mold | | | | |
|---|---|---|---|---|---|---|
| Bunch | wt.* | Visible | Hidden | Infested | Misc. culls | Total culls |
| ID | lb | % | % | % | % | % |
| 1 | 7.7 | 0 | 0 | 0 | 0 | 0 |
| 2 | 16.5 | 1 | 2 | 0 | 2 | 5 |
| 3 | 13.6 | 0 | 2 | 0 | 6 | 8 |
| 4 | 11.5 | 0 | 0 | 0 | 2 | 2 |
| 5 | 12.7 | 1 | 0 | 0 | 5 | 6 |
| 6 | 8.1 | 0 | 0 | 0 | 3 | 3 |
| 7 | 20.9 | 0 | 1 | 0 | 3 | 4 |
| 8 | 17.5 | 2 | 5 | 0 | 8 | 15 |
| 9 | 8.8 | 0 | 0 | 0 | 3 | 5 |
| 10 | 8.8 | 0 | 0 | 0 | <1 | 0 |
| Average | 13.0 | <1 | 1 | 0 | 3 | 5 |

*Gross wt. minus 3% average unripe (yellows and turning)

TABLE 2
2016 Field Trial Results
Date variety: Medjool
30 gsm (.9 oz) polyethylene spunbond nonwoven fabric
w/kraft paper hood outside
16 JUL 2016-30 OCT 2016
Location: Farnot Ranch, Thermal, California
No. of pickings: 1 Tree age: 9 yr Spacing: 15′ × 16.6′ diamond
Rainfall: 10 mm (.40 in), 21 SEP 2016 and 8 mm (.31 in),
23 OCT-24 OCT 2016

| | Net | Black Mold | | | | |
|---|---|---|---|---|---|---|
| Bunch | wt.* | Visible | Hidden | Infested | Misc. culls | Total culls |
| ID | lb | % | % | % | % | % |
| 47E | 12.8 | 0 | 1 | 0 | 0 | 1 |
| 63E | 7.6 | 0 | 0 | 0 | 0 | 0 |
| 63W | 17.4 | 2 | 1 | 0 | 1 | 4 |
| 66E | 25.0 | 2 | 2 | 0 | 0 | 4 |
| 1010E | 11.9 | 0 | 1 | 0 | 0 | 1 |
| Average | 14.9 | 1 | 1 | 0 | <1 | 2 |

*Gross wt. minus 7% average unripe (yellows and turning)

### BRIEF DESCRIPTION OF THE SEVERAL VIEWS OF THE DRAWINGS

FIG. 1 is a plan view of two panels of fabric seamed together with which to form a bunch cover in accordance with the preferred embodiment of the present invention.

FIG. 2 is a front plan view of the panels folded perpendicular to the seam joining them.

FIG. 3 is a rear plan view thereof.

FIG. 4 is an elevation view thereof showing the panels in a tubular configuration.

FIG. 5—Prior Art—is a plan view of a section of a tube formed by folding a continuous sheet of fabric perpendicular to its length and bonding its sides together in accordance with an alternate embodiment of the present invention.

FIG. 6 is a front plan view of a folded and bonded panel cut from the section with a strap attached near the bottom.

FIG. 7—Prior Art—is a plan view of a rectangular sheet of rainproof material with two corner cuts for making a rain hood.

FIG. 8—Prior Art—is an elevation view of a rain hood alone for better illustration.

FIG. 9 is an elevation view of the section of the tube shown in FIG. 6 installed on a date bunch with the rain hood on the outside.

FIG. 10 is an elevation view of the preferred embodiment installed on a date bunch.

### DETAILED DESCRIPTION OF THE INVENTION

While the present invention lends itself to embodiment in various forms, there is shown in the drawings, and will hereinafter be described, the preferred embodiment and an alternate, with the understanding that the present disclosure is to be considered as an exemplification of the present invention, and is not intended to limit the invention to the specific embodiments illustrated.

Referring now to the drawings, the preferred embodiment as shown in FIG. 4 combines two styles of polypropylene spunbond nonwoven fabric into a tube-shaped date-bunch cover 9, of which a heavy-weight, 50 gsm (1.5 oz/yd²), rainproof, UV-resistant style comprises roughly the upper 40 cm (16 in) to 50 cm (20 in) portion, and a medium-weight, 30 gsm (0.9 oz/yd²), porous style comprises roughly the lower 70 cm (28 in) to 80 cm (32 in). The cover measures approximately 76 cm (30 in) when laid flat.

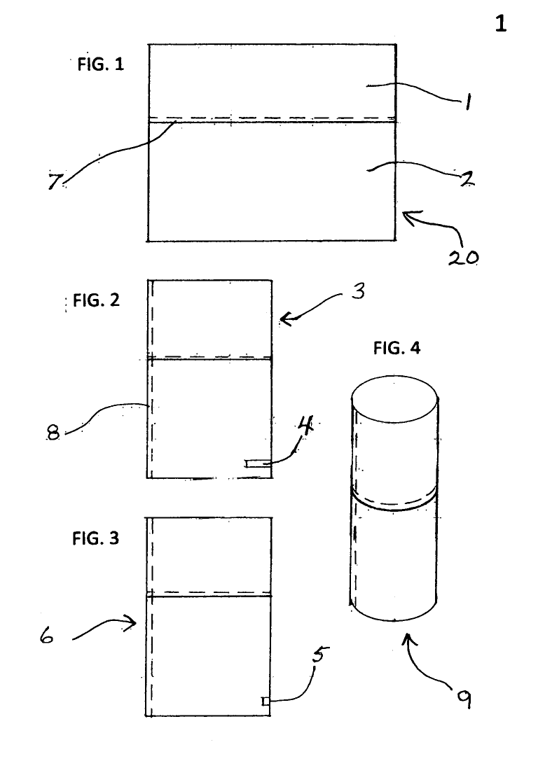

Turning now to FIGS. 1, 2, and 3, the preferred embodiment is made by seaming 7 a long side of a 150 cm (60 in)×50 cm (20 in) panel of heavy-weight style 1, and a long side of the 150 cm (60 in)×76 cm (30 in) panel of medium-weight style 2. Next, the joined panels are folded perpendicular to the long sides 3 and seamed on the short edges 8 to form the cover.

As shown in FIG. 3, a VELCRO® brand ONE WRAP® strap, 18 cm (7 in) long×1.6 cm (⅝ in) wide, is attached 7.6 cm (3 in) from the bottom of the cover, by folding 2.5 cm (1 in) 5 of the strap over the folded side of the cover, and sewing through the fabric to join the 2.5 cm (1 in) section and the 15 cm (6 in) section 4 of the strap.

As shown in FIG. 10, the cover 23 is slipped around the bottom of a bunch, raised up and fastened with a twist tie to a fruitstalk 22. The bottom of the cover is closed with the strap 24, thereby encapsulating the bunch.

In addition to protecting the dates, the cover catches the ones that naturally drop or high winds knock off the fruitstrands. The dates are harvested by opening the strap and removing the ones that dropped, hand-picking the ripe ones on the fruitstrands, and then closing the bottom. This operation can be done multiple times, or only once after all the dates have ripened.

After completing the harvest, the bottom is left open, and the cover detached from the fruitstalk and removed from the bunch. The cover is then bundled and stored until the next season. The two styles of fabric comprising the cover are serviceable one to four seasons depending on their weight.

An alternate embodiment, as shown in FIG. 9, utilizes 50# wet-strength, kraft paper instead of the heavy-weight style of polyethylene spunbond nonwoven fabric for protecting the bunch against rain. FIG. 5 shows a roughly 4 m (14 ft) length 10 of a 150 m (500 ft) long×76 cm (30 in) wide tube formed from a 150 m (500 ft) long×150 cm (60 in) wide roll of light-weight, 19 gsm (0.55 oz/yd²), porous style, or medium-weight porous style, folded in half sideways and glued together 11. The lines 12 mark where the tube will be cross-cut into sections approximately 120 cm (48 in) long.

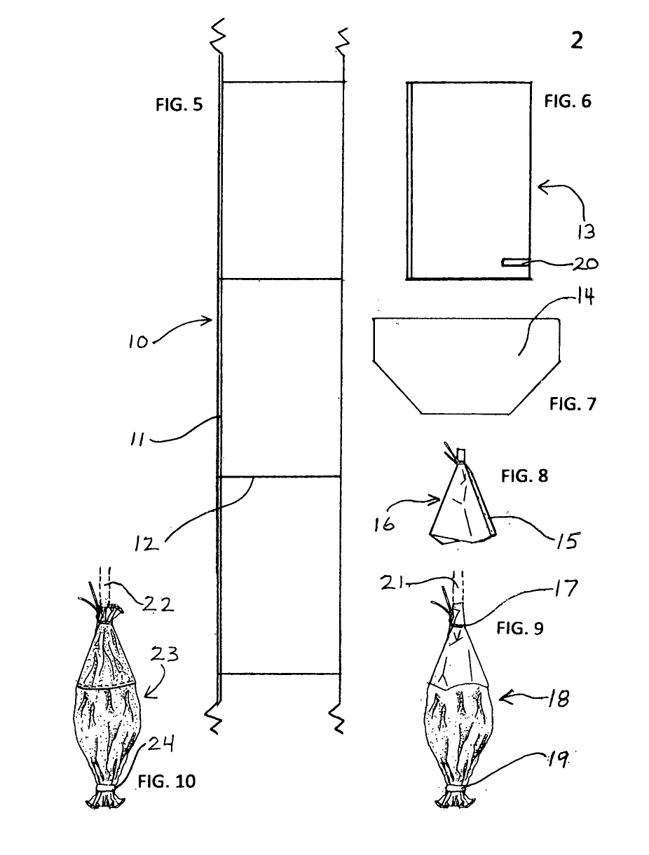

FIG. 6 shows one of the sections 13 with a strap attached to it in the same manner and location as described above. Each section forms a cover that is of ample size to encapsulate the bunch, and which is installed and removed in the same manner as described above.

The rain hood shown in FIGS. 8 and 9 is made from a sheet 14 of 50# unbleached, wet-strength, semi-extensible, kraft paper, 120 cm (48 in) long×60 cm (24 in) wide, having two diagonal 33 cm (13 in) corner cuts as shown in FIG. 7, which give the cone-shaped hood 16 an even horizontal bottom when formed and stapled 15 in place. FIG. 9 shows the sheet wrapped over roughly 50 cm (20 in) of the upper portion of the cover 18, and fastened to the fruitstalk 21 with a twist tie 17.

After harvesting the dates, the bottom of the cover is left open, and the cover and rain hood are detached from the fruitstalk and removed from the bunch. The cover is then bundled and stored until the next season unless worn out.

The rain hood and the bunch are either burned, or buried, or disked into the soil and soaked with irrigation water to hasten decomposition, or alternatively shredded and left on the soil for mulch. The paper is FDA compliant, biodegradable and compostable.

It will be readily apparent to those skilled in the art that various changes and modifications of an obvious nature may be made without departing from the spirit and scope of the present invention.

I claim:

1. A protective cover, comprising a tubular configuration sized to encapsulate a date bunch, which protects the dates from rain, excludes insects and birds, allows aeration of the fruit cluster, and provides partial shade, the improvement wherein said protective cover has two panels made of polyethylene spunbond nonwoven fabric seamed horizontally to form said tubular configuration, whereby the upper panel is rainproof and the lower panel is porous.

2. A protective cover, comprising a tubular configuration made of porous fabric and sized to encapsulate a date-bunch, which excludes insects and birds, allows aeration of the fruit cluster, and provides partial shade, in combination with a sheet of rainproof material that is wrapped around the upper portion of the bunch to form a hood, either inside or outside said tubular configuration, the improvement wherein said porous fabric is polyethylene spunbond nonwoven fabric.

3. A method of protecting date bunches, comprising the steps of:
(a) cutting two rectangular panels of polyethylene spunbond nonwoven fabric, one of which is rainproof and the other is porous, comprising said upper and lower portions, respectively, of a tube-shaped cover, which is sized to encapsulate a date bunch,
(b) seaming one long edge of each said panel to one long edge of the other by heat-bonding, adhesive-bonding, or sewing,
(c) folding said panels in half, short-edge to short-edge, and seaming them by heat-bonding, adhesive-bonding, or sewing, thereby forming said cover,
(d) attaching a strap near the bottom of said cover by folding a strap over the folded side of said cover, and bonding it to said folded side of said cover,
(e) slipping the top of said cover around the bottom of a bunch, raising it up and fastening it to the fruitstalk with a twist tie,
(f) closing the bottom of said cover with said strap, whereby encapsulating the bunch.

4. A method of protecting date bunches, comprising the steps of:
(a) cutting a rectangular panel of porous polyethylene spunbond nonwoven fabric, sized to encapsulate a date bunch,
(b) seaming one long edge of each said panel to one long edge of the other by heat-bonding, adhesive-bonding, or sewing,
(c) folding the short edges perpendicularly to the long edges of said panel, and seaming them by heat-bonding, adhesive-bonding, or sewing, to form a tube-shaped cover,
(d) attaching a strap near the bottom of said cover by folding a strap over the folded side of said cover, and bonding it to said folded side of said cover,
(e) slipping the top of said cover around the bottom of a bunch, raising it up and fastening it to the fruitstalk with a twist tie,
(f) closing the bottom of said cover with said strap, whereby encapsulating the bunch,
(g) wrapping a sheet of rainproof material around the upper portion of said cover, and stapling said sheet into a cone-shaped hood,
(h) fastening said hood to a fruitstalk with a twist tie on the outside of said cover, thereby forming a cover, combining said fabric and said sheet.

5. The method of claim 4, wherein said hood is fastened to a fruitstalk with a twist tie on the inside of said cover, thereby forming a cover combining said fabric and said sheet.
